(19) United States
(12) Patent Application Publication
(10) Pub. No.: US 2003/0014575 A1
(43) Pub. Date: Jan. 16, 2003

(54) Single-unit multiple-transmission device

(76) Inventors: Lun Wang, Taipei (TW); Wen-Hua Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/902,162

(22) Filed: Jul. 11, 2001

(51) Int. Cl. G06F 3/00

(52) U.S. Cl. 710/62

(57) ABSTRACT

A single-unit multiple-transmission device is installed in a computer system that involves the use of various wireless input peripherals, comprising a computer main unit that has a receptor, and an input device that is composed of at least a keyboard, a mouse and a game control. The wireless input peripheral devices respectively have a transmitter that is composed of an RF module; the transmitters are controlled by CPUs to transmit control signals to the computer main unit at different channels. The computer main unit includes a scanning mechanism on its receptor, this scanning mechanism is controlled by a CPU to receive signals transmitted from various input devices at different times during the scanning operation, the signals are then transmitted to the computer main unit through a USP port. Based on the above, the computer main unit of the single-unit multiple-transmission device is capable of simultaneous reception of different input signals.

### BACKGROUND OF THE INVENTION

1. Field of the Invention

This invention relates to a single-unit multiple-transmission device, in particular to a device, which can be applied to a computer system involving the use of various wireless input peripherals. The receptor of a computer main unit is capable of receiving signals from different input peripherals at different times, to upgrade operational efficiency of wireless transmission devices.

2. Background of the Invention

Conventionally, between the computer and its input peripherals, an appropriate transmission interface must be installed, and signal transmission cables must be used to connect them, for the purpose of signal conversion and data transmission. In recent years, however, the computer system has further used wireless signal transmitters and receptors, to receive control signals transmitted from various wireless input peripherals, such as through USB signal transmitters, so all USB peripherals can control and operate the computer by wireless transmission.

Generally, the signal transmission module and signal reception module of wireless peripherals and computer system involve RF modules to transmit and receive signals. And, because of the introduction of more and more wireless peripherals, such as wireless keyboard, wireless mouse, or wireless joystick as game control, etc. In case of improper distribution of channels between signal transmission and signal reception systems, interference would often be the result. Besides, for transmission between the wireless input peripheral and the computer main unit, the wireless input peripheral must transmit identification signals repeatedly at a specified interval of time, but the computer main unit is unable to receive and identify the signals transmitted from various wireless peripherals at the same time. The result would often be failure of the transmitter module, even adverse effect to the normal performance of the computer main unit's distant-end wake-up function.

### SUMMARY OF THE INVENTION

The primary objective of this invention is to provide a single-unit multiple-transmission device, applicable to a computer system that involves the use of various wireless input peripherals. The receptor of the computer main unit serves to receive signals respectively transmitted from different input peripherals at different times. The invention has upgraded the operation efficiency of wireless transmission devices in a time-divided and labor-divided way.

According to the invention, the single-unit multiple-transmission device comprises a computer main unit having a receptor, and an input device that is composed of at least a keyboard, a mouse and a game control joystick; wherein, on respective input peripheral is a transmitter that is composed of an RF module. A CPU controls said transmitter to transmit control signals to the computer main unit at different channels. The compute main unit includes a scanning mechanism that is installed on its signal receptor. A CPU controls this scanning mechanism to receive signals transmitted at different times from different input devices during the scanning operation; the signals are then transmitted to the computer main unit through a USP port, thereby composing a single-unit multiple-transmission device involving a computer main unit to simultaneously receive signals transmitted from various input peripherals.

Another objective of this invention is to provide a single-unit multiple-transmission device that is, in a time-divided and labor-divided way, capable of simultaneously receiving signals transmitted from various input peripherals, by the scanning operation of a receptor between various single USB wireless input peripherals and a computer main unit, thereby upgrading the efficiency of wireless signal input, yet preventing mutual interference between wireless peripherals.

### BRIEF DESCRIPTION OF THE DRAWING

The drawing of preferred embodiment of this invention is described in following details to enable better understanding.

FIG. 1 is a block diagram of the invention.

### DETAILED DESCRIPTION OF PREFERRED EMBODIMENT

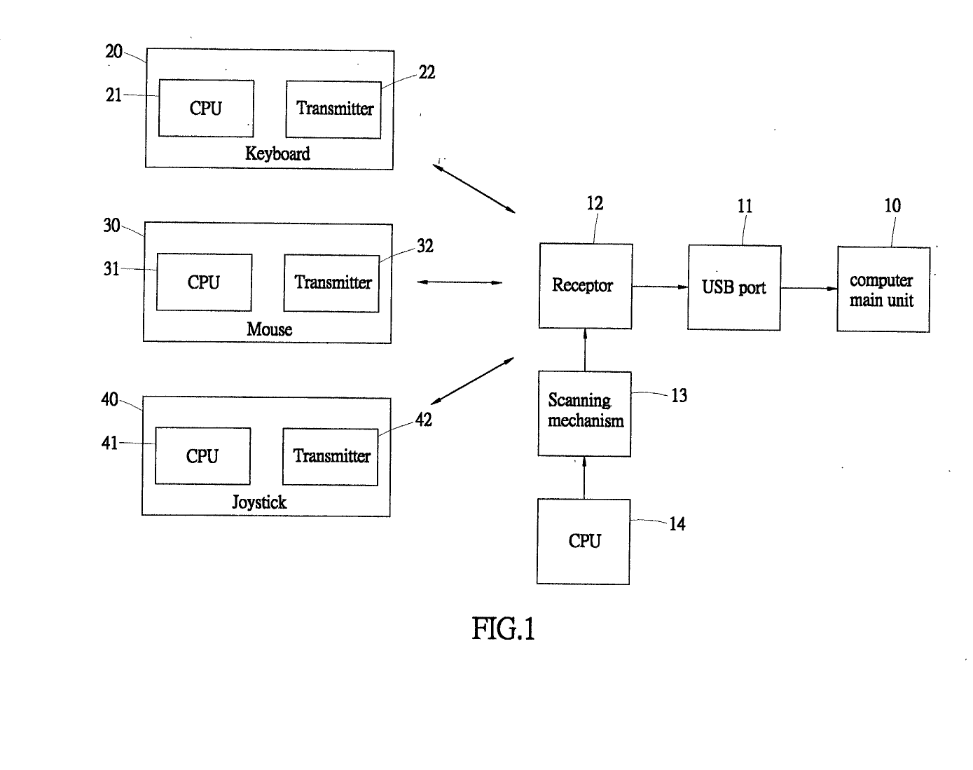

As shown in FIG. 1, a single-unit multiple-transmission device of the invention is applicable to a computer system that involves the use of various wireless input peripherals, which comprises a computer main unit 10 that has a wireless signal receptor 12, and a wireless input device that is composed of a various single-unit peripherals, such as keyboard 20, a mouse 30 and a game control 40.

As shown in FIG. 1, the signal receptor 12 installed on the computer main unit 10 comprises a scanning mechanism 13. This scanning mechanism 13 controlled by a CPU 14 is capable of receiving signals transmitted respectively at different times from the aforementioned various wireless input devices, during the scanning operation, the signals are then transmitted through a USB port 11 to the computer main unit 10.

The keyboard 20 includes a transmitter 22 that is composed of an RF module on the keyboard 20, and a CPU 21. The CPU 21 serves to control the RF module of the transmitter 22, transmitting control signals of the keyboard 20 at a different channel to the computer main unit 10.

The mouse 30 includes a transmitter 32 that is composed of an RF module on the mouse 30, and a CPU 31. The CPU 31 serves to control the transmitter 32, transmitting control signals of the mouse 30 at a different channel to the computer main unit 10.

The game control 40 includes a transmitter 42 that is composed of an RF module, and a CPU 41. The CPU 41 serves to control the transmitter 42, transmitting the control signals of the game control 40 at a different channel to the computer main unit 10.

Each single-unit wireless input device, such as the keyboard 20, the mouse 30 or the game control 40, is respectively controlled by the CPU 21, 31 or 41, their RF modules transmitting control signals at different channels to the computer main unit 10. The receptor 12 of the computer main unit 10 controls the scanning mechanism 13 to operate scanning performance through the CPU 14, receiving respective input signals at respective channels at different times during the scanning operation, the signals are then transmitted to the computer main unit 10 through the USP port 11. Thus, it achieves the objective of single-unit multiple-input, and time-divided and labor divided operation without missing any signals.

As described above, the subject single-unit multiple-transmission device is specially designed for application to wireless signal transmission between the computer main unit and the various wireless input devices. The receptor of the computer main unit serves to receive multiple signals at different times by scanning process, to achieve the anticipated objective of time-divided, labor-divided, reception of multiple packets of signals.

Besides, the subject single-unit multiple-transmission device receives signals transmitted by various input peripherals in a time-divided and labor-divided way. Therefore, it will upgrade the efficiency of input and reception of wireless signals, preventing mutual interference between respective wireless input peripherals, so as to obtain excellent transmission quality in the transmission and reception of respective control signals.

What is claimed is:

1. A single-unit multiple-transmission device, applicable to a computer system that involves the use of various wireless input peripherals, comprising a computer main unit having a wireless signal receptor, and a wireless input device that is composed of various single-unit peripherals, such as a keyboard, a mouse, and a game control, characterized in that:
the keyboard includes a transmitter that is composed of an RF module and a CPU, said CPU serving to control the RF module of the transmitter, transmitting control signals of the keyboard at a different channel to the computer main unit;
the mouse includes a transmitter that is composed of an RF module, and a CPU, said CPU serving to control the transmitter, transmitting control signals of the mouse at a different channel to the computer main unit;
the game control includes a transmitter that is composed of an RF module, and a CPU, said CPU serving to control the transmitter, transmitting the control signals of the game control at a different channel to the computer main unit; and
the computer main unit includes a scanning mechanism on its signal receptor, said scanning mechanism being controlled by a CPU, receiving signals transmitted from different wireless input devices at different times during the scanning operation, the signals then transmitted to the computer main unit through a USP port, thus achieving the objective of receiving all multiple signals in a time-divided and labor-divided way.

2. The single-unit multiple-transmission device as claimed in claim 1, wherein the computer main unit receives signals transmitted from different input peripherals in a time-divided and labor-divided way, but preventing mutual interference between various input devices.
